(19) United States
(12) Patent Application Publication
(10) Pub. No.: US 2004/0143584 A1
(43) Pub. Date: Jul. 22, 2004

(54) Method for optionally changing tree-form directory

(76) Inventors: Ding Lien Chun, Taoyuan (TW); Lee Ching Kang, Taipei (TW)

Correspondence Address: Kirton & McConkie, 1800 Eagle Gate Tower, 60 East South Temple, P.O. Box 45120, Salt Lake City, UT, 84145-0120, US

(21) Appl. No.: 10/417,492

(22) Filed: Apr. 17, 2003

(30) Foreign Application Priority Data
Jan. 17, 2003 (TW) 92101058

(51) Int. Cl. G06F 7/00

(52) U.S. Cl. 707/100

(57) ABSTRACT

A method for optionally changing a hierarchical directory tree in a web page is provided in the present invention. The hierarchical directory tree includes a plurality of classified data, and is stored in a database. Each of the classified data includes a superior node number and an internal category number. The method includes steps of selecting a first classified data group from the plurality of classified data to form a first catalog, selecting a second classified data group from the plurality of classified data to form a second catalog, and moving a second classified data from the second catalog into the first catalog, and amending a second superior node number of the second classified data with a first internal category number of a first classified data of the first catalog.

### FIELD OF THE INVENTION

This invention relates to a method for optionally changing a hierarchical relationship of the directory, and especially to a method for optionally changing a hierarchical directory tree used in web pages.

### BACKGROUND OF THE INVENTION

An important use of computers is the transfer of information over a network. Currently, the largest computer network in existence is the Internet. The Internet is a worldwide interconnection of computer networks that communicate using a common protocol. Millions of computers, from low-end personal computers to high-end super computers are coupled to the Internet.

The Internet grew out of work funded in the 1960s by the U.S. Defense Department's Advanced Research Projects Agency. For a long time, Internet was used by researchers in universities and national laboratories to share information. As the existence of the Internet became more widely known, many users outside of the academic/research community (e.g., employees of large corporations) started to use Internet to carry electronic mail.

In 1989, a new type of information system known as the World-Wide-Web (“the Web”) was introduced to the Internet. Early development of the Web took place at CERN, the European Particle Physics Laboratory. The Web is a wide-area hypermedia information retrieval system aimed to give wide access to a large universe of documents. At that time, the Web was known to and used by the academic/research community only. There was no easily available tool, which allows a technically untrained person to access the Web.

In 1993, researchers at the National Center for Supercomputing Applications (NCSA) released a Web browser called “Mosaic” that implemented a graphical user interface (GUI). Mosaic's graphical user interface was simple to learn yet powerful. The Mosaic browser allows a user to retrieve documents from the World-Wide-Web using simple point-and-click commands. Because the user does not have to be technically trained and the browser is pleasant to use, it has the potential of opening up the Internet to the masses.

The architecture of the Web follows a conventional client-server model. The terms “client” and “server” are used to refer to a computer's general role as a requester of data (the client) or provider of data (the server). Under the Web environment, Web browsers reside in clients and Web documents reside in servers. Web clients and Web servers communicate using a protocol called “HyperText Transfer Protocol” (HTTP). A browser opens a connection to a server and initiates a request for a document. The server delivers the requested document, typically in the form of a text document coded in a standard Hypertext Markup Language (HTML) format, and when the connection is closed in the above interaction, the server serves a passive role,.i.e., it accepts commands from the client and cannot request the client to perform any action. Nowadays, because of the characteristics of instantaneousness, interaction, multimedia, low cost and far-fetching availability, Internet becomes a new access to success for modern industries. Furthermore, it is going to be a trend in the near future. In E-commerce field, visual shop shows in the form of “Business to Consumer” (B2C) . “Visual shop” means customers shop through Internet while the company benefit by cutting down the cost. However, the problem is that the user does not have to be technically trained but may establish and manage a professional commodity database without professional knowledge.

Traditionally, a general Hint electrical business system always has a display page with a hierarchical directory tree for user to inquire conveniently. In general, the management panel needs to modify the contents of the web page, to change the color of the field, and to update the information anytime. However, the program of the database in the business system must be amended while changing the classical catalog. Therefore, for a manager without professional programming knowledge, it's difficult to update the display web page of the electrical business system frequently. Because the programs must be amended or rewritten while merely changing the classical catalogs, the men power and materials are wasted meaningless.

Because of the technical defects described above, the applicant keeps on carving unflaggingly to develop a “METHOD FOR OPTIONALLY CHANGING TREE-FORM DIRECTORY” through wholehearted experience and research.

### SUMMARY OF THE INVENTION

It is an object of the present invention to provide a network station, which can be operated easily by a network station manager.

It is another object of the present invention to provide a hierarchical directory tree, which can be easily rearranged by a web page manager.

It is another object of the present invention to provide a method for optionally changing a hierarchical directory tree in a web page. The hierarchical directory tree includes plural classified data, and is stored in a database. Each of the classified data includes a superior node number and an internal category number. The method includes steps of: a) selecting a first classified data group from the plural classified data to form a first catalog; b) selecting a second classified data group from the plural classified data to form a second catalog; and c) moving a second classified data from the second catalog into the first catalog, and amending a second superior node number of the second classified data with a first internal category number of a first classified data of the first catalog.

Preferably, the first catalog includes at least the first classified data.

Preferably, the second catalog includes at least the second classified data.

Preferably, the step a) further includes steps of: a1) selecting a third classified data group from the plural classified data to form a third catalog; and a2) moving a third classified data from the third catalog into the first catalog, and amending a third superior node number of the third classified data with the first internal category number.

Preferably, the third classified data includes at least the third classified data.

In accordance with another aspect of the present invention, a method for changing a tree-form data is provided. The method includes steps of: a) providing a database; b) storing plural classified data in the database, and each of the plural classified data comprises a superior node number and an internal category number respectively; c) selecting a first classified data group and a second classified data group from the plural classified data; and d) moving a second classified data from the second classified data group into the first classified data group, and amending a second superior node number of the second classified data with a first internal category number of a first classified data of the first classified data group.

Preferably, the plural classified data are listed in a tree form.

Preferably, the first classified data group includes at least the first classified data.

Preferably, the second classified data group includes at least the second classified data.

Preferably, the step c) further includes steps of: c1) selecting a third classified data group from the plural classified data; and c2) moving a third classified data from the third classified data group into the first classified data group, and amending a third superior node number of the third classified data with the first internal category number.

Preferably, wherein the third classified data includes at least the third classified data.

It is the other object to provide a method for optionally changing a hierarchical directory tree in a web page, wherein the hierarchical directory tree includes plural classified data, and each of the plural classified data including a first identified number and a second identified number. The method includes steps of: a) selecting at a least first classified data from the plural classified data to form a first directory; b) selecting at least a second classified data from the plural classified data to form a second directory; and c) moving one of the at least a second classified data from the second directory to the first directory, and changing the first identified number of the moved one of the at least a second classified data as the second identified number of the at least a first classified data.

Preferably, the plural classified data are stored in a database.

Preferably, the first identified number is a superior node number.

Preferably, the second identified number is an internal category number.

For understanding this application further, some figures and detail illustrations are shown as follows:

### BRIEF DESCRIPTION OF THE DRAWINGS

FIG. 1(A) shows a schematic diagram of an unchanged directory with its backend structural items according to a preferred embodiment of the present invention;

FIG. 1(B) shows a front-end display page of an unchanged directory according to a preferred embodiment of the present invention;

FIG. 2(A) shows a schematic diagram of an changed directory with its backend structural items according to a preferred embodiment of the present invention;

FIG. 2(B) shows a front-end display page of an changed directory according to a preferred embodiment of the present invention;

FIG. 3(A) shows a schematic diagram of the unchanged hierarchical directory tree according to a preferred embodiment of the present invention;

FIG. 3(B) shows a schematic diagram of the changed hierarchical directory tree according to a preferred embodiment of the present invention.

### DETAILED DESCRIPTION OF THE PREFERRED EMBODIMENT

The present invention will now be described more specifically with reference to the following embodiments. Please refer to FIGS. (A) and (B), which are the schematic diagrams of the unchanged directory according to a preferred embodiment of the present invention. FIG. (A) shows a schematic diagram of the back-end structural items, and FIG. (B) shows a schematic diagram of the front-end display page. The catalogs of the directory can be changed optionally. Because the information data of different grades can be changed that a revolution of information management has been ignited. The revolution simplifies the operation procedures and the information can be easily managed just by “one click”.

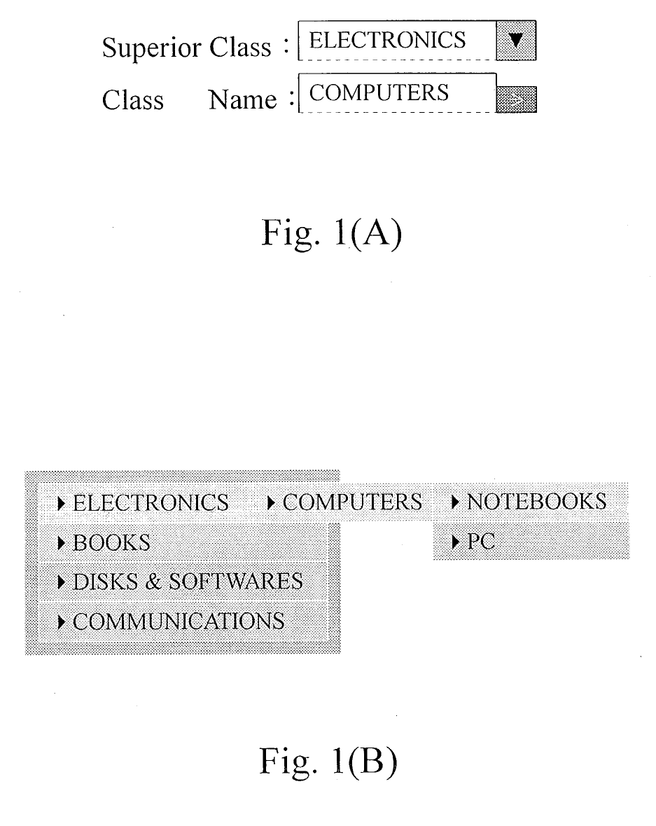

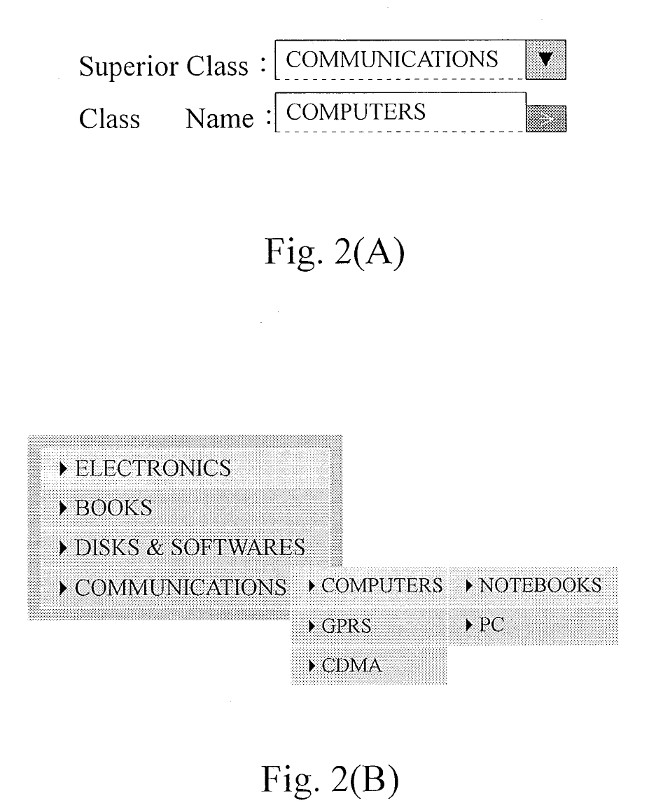

As shown in FIG. 1(A), when the superior class is electrics the subordinate class is computers. To rewrite the programs for redistributing the database is a general way of moving a subordinate class as computers into another superior class as communications, and the result is shown in FIG. 2(A). With the method provided by the present invention, it's convenient and practicable to change the catalogs optionally regardless of what's its designed class in advance without any logic fault. FIG. 2(A) and FIG. 2(B) show the schematic diagrams of the directory after being changed. FIG. 2(A) shows a schematic diagram of the changed directory with its backend structural items and FIG. 2(B) shows a front-end display page of the changed directory.

Another advantage of the present invention is to establish a new database easily. In the database, each datum has an internal category number for marking its own classic information and a superior node number called parent node for recording its superior class. The superlative superior node number is zero. A hierarchical directory tree is come out by redistributing all the data with their superior node numbers

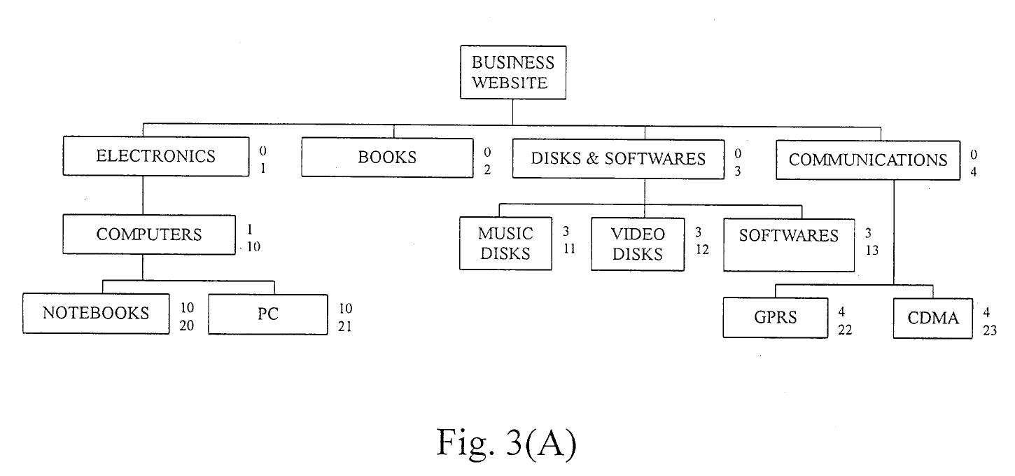

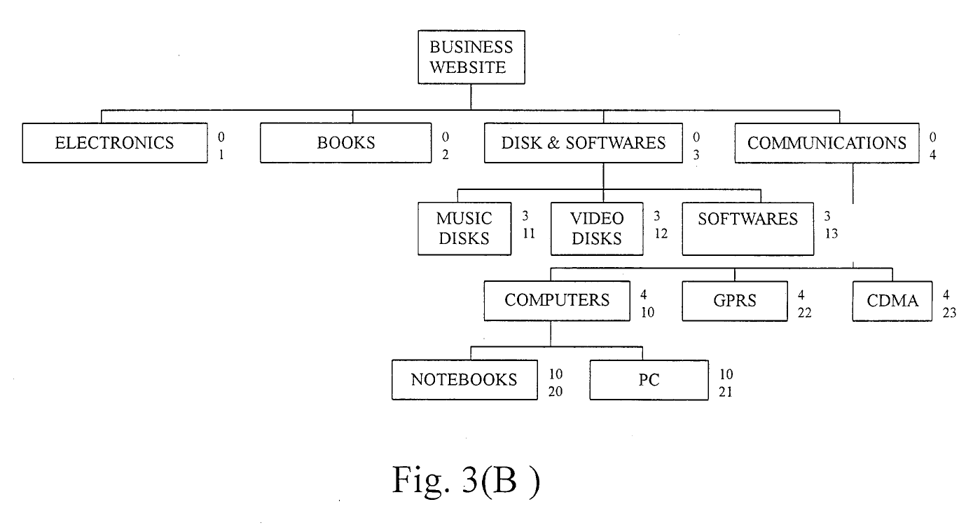

As shown in FIGS. 3(A) and 3(B), each datum has its internal category number, which could be any number except zero and is demarcated at the lower right corner, and a superior node number, a parent node number for recording which catalog is the superior class of the datum, at the upper right corner. It is easy to redistribute the structure of the directory by amending the superior node number of a datum and moving the whole branch including the datum and its subordinate data. The display page of the website will be changed in accordance with the movement of the branch. For example, as shown in FIGS. 3(A) and 3(B), the COMOPUTERS can be easily moved from the ECLECTRONICS to the COMMUNICATIONS by amending its superior node number form 1 to 4.

As above-mentioned, the present invention can easily achieve the goal of changing the catalogs of a directory optionally and quickly. Thus, the invention provides a design with easy-operation and convenience for the users. Therefore, the invention has originality, novelty and progressiveness. Things like that, effectively improving the defaults of the prior arts and being worthy for the industries are the purposes of the present invention.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A method for optionally changing a hierarchical directory tree in a web page, wherein said hierarchical directory tree comprises plural classified data, each of said classified data comprising a superior node number and an internal category number, and is stored in a database, comprising steps of:
a) selecting a first classified data group from said plural classified data to form a first catalog;
b) selecting a second classified data group from said plural classified data to form a second catalog; and
c) moving a second classified data from said second catalog into said first catalog, and amending a second superior node number of said second classified data with a first internal category number of a first classified data of said first catalog.

2. The method as claimed in claim 1, wherein said first catalog comprises at least said first classified data.

3. The method as claimed in claim 1, wherein said second catalog comprises at least said second classified data.

4. The method as claimed in claim 1, wherein said step a) further comprises steps of:
a1) selecting a third classified data group from said plural classified data to form a third catalog; and
a2) moving a third classified data from said third catalog into said first catalog, and amending a third superior node number of said third classified data with said first internal category number.

5. The method as claimed in claim 4, wherein said third classified data comprises at least said third classified data.

6. A method for changing a tree-form data, comprising steps of:
a) providing a database;
b) storing plural classified data in said database, and each of said plural classified data comprises a superior node number and an internal category number respectively;
c) selecting a first classified data group and a second classified data group from said plural classified data; and
d) moving a second classified data from said second classified data group into said first classified data group, and amending a second superior node number of said second classified data with a first internal category number of a first classified data of said first classified data group.

7. The method as claimed in claim 6, wherein said plural classified data are listed in a tree form.

8. The method as claimed in claim 6, wherein said first classified data group comprises at least said first classified data.

9. The method as claimed in claim 6, wherein said second classified data group comprises at least said second classified data.

10. The method as claimed in claim 6, wherein said step c) further comprises steps of:
c1) selecting a third classified data group from said plural classified data; and
c2) moving a third classified data from said third classified data group into said first classified data group, and amending a third superior node number of said third classified data with said first internal category number.

11. The method as claimed in claim 10, wherein said third classified data comprises at least said third classified data.

12. A method for optionally changing a hierarchical directory tree in a web page, wherein said hierarchical directory tree comprises plural classified data, and each of said plural classified data comprising a first identified number and a second identified number, comprises steps of:
a) selecting at a least first classified data from said plural classified data to form a first directory;
b) selecting at least a second classified data from said plural classified data to form a second directory; and
c). moving one of said at least a second classified data from said second directory to said first directory, and changing said first identified number of said moved one of said at least a second classified data as said second identified number of said at least a first classified data.

13. The method as claimed in claim 12, wherein said plural classified data are stored in a database.

14. The method as claimed in claim 12, wherein said first identified number is a superior node number.

15. The method as claimed in claim 12, wherein said second identified number is an internal category number.
